(19) United States
(12) Patent Application Publication
(10) Pub. No.: US 2005/0066170 A1
(43) Pub. Date: Mar. 24, 2005

(54) Method of managing a token in a telecommunications network

(75) Inventors: Guylaine Queau, Verrieres-de-Buisson (FR); Laurent Thiebaut, Antony (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/944,860

(22) Filed: Sep. 21, 2004

(30) Foreign Application Priority Data
Sep. 22, 2003 (FR) 03 11 098

(51) Int. Cl. H04L 9/00

(52) U.S. Cl. 713/172

(57) ABSTRACT

A method of managing a token in a telecommunications network to allocate an exclusive right to one user out of a group of users who can request simultaneously to benefit from the same service; the method consisting in:
a requesting user (EU_{A}) sending (1) a token request to an application server (AS); the application server (AS) then allocating (2) a single token to a requesting user; the requesting user who has received the token then sending (3) data to a media server (MS) suitable for transporting the data;
said user (EU_{A}) sending (4) a token-release request to the application server (AS); and
finally said application server (AS) broadcasting (5) a message to all of the users (EU_{A}, . . . , EU_{D}) indicating that the token is available.

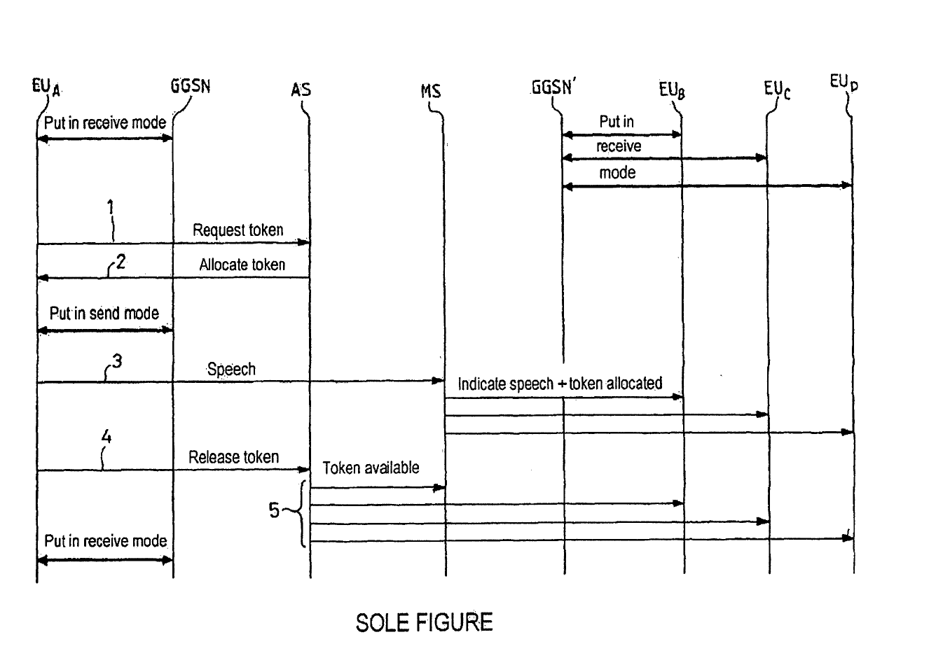

The invention relates to a method of managing a token in a telecommunications network. Such a method is used when it is necessary to give an exclusive right to one user out of a group of users who can request simultaneously to benefit from a single service. For example, the method can be applied to giving turns to speak in a telephone conference when it is desired to avoid having a plurality of users speaking at once.

A method is known for managing a token in a third generation mobile telephone network. That known method is implemented in the so-called transport layer of the layer architecture constituting a model of such a network. The protocol used in the transport layer is intended, a priori, for transmitting signaling messages that are specific to transporting voice signals, and more generally multimedia signals. It is not satisfactory for managing a token: a signaling message at the transport layer level might be lost. That means a token can be lost, and as a result that nobody is allocated a turn to speak until some additional mechanism creates a new token (e.g. after a time-out). In addition, that known method has the drawback that the so-called application layer, which serves to manage applications, is not informed of events relating to the token, since those events take place in the transport layer.

The object of the invention is to remedy those drawbacks. The invention provides a method of managing a token in a telecommunications network to allocate an exclusive right to one user out of a group of users who can request simultaneously to benefit from the same service; the method being characterized in that it consists in:
a requesting user sending a token request to an application server;
the application server then allocating a single token to a requesting user;
the requesting user who has received the token then sending data to a media server suitable for transporting the data;
said user sending a token-release to the application server; and
finally said application server broadcasting a message to all the users indicating that the token is available.

The method as characterized in this way provides token management that is more reliable since signaling in the application layer level provides a better guarantee of a message being delivered to its destination. Furthermore, token management can be integrated in one of the application of said layer, since it makes use of the signaling of the layer. Such an application is then directly aware of the events of the token being allocated and restored, and can therefore co-operate more easily with various applications for providing services to users in a telecommunications network.

The method also has the advantage of releasing the transport layer from the task of managing the token. This leads to greater efficiency in the transport layer and also in the application layer.

The invention will be better understood and other characteristics will appear on reading the following description given with reference to the sole accompanying figure. Consideration is given by way of example to a third generation mobile telephone network in which the method of the invention is implemented to allocate a speaking turn to a single user amongst a group of users EU_{A}, EU_{B}, EU_{C}, and EU_{D} taking part in a telephone conference. The method is implemented in the application layer which is then referred to as the call control layer; and the signaling protocol used for this implementation is the session initiation protocol (SIP). The entities involved in this example are as follows:
two access control servers GGSN and GGSN′ implementing the real-time transport protocol (RTP), the server GGSN serving the terminal EU_{A} and the server GGSN′ serving the terminals EU_{B}, EU_{C} and EU_{D};
an application server AS; and
a media server MS.

The user terminals EU_{A}, EU_{B}, EU_{C}, EU_{D} have previously requested to participate in the same conference in conventional manner. One of the access control servers GGSN or GGSN′ has set up a connection between each of the user terminals EU_{A}, EU_{B}, EU_{C}, and EU_{D} and the network, and has initialized the connections so that the terminals are in receive mode, i.e. none of them has the right to speak for the moment. In order to allow a user to speak, the user must previously have made a request to speak by activating a function of the corresponding user terminal EU_{A}.

During a step 1, the terminal EU_{A} sends a request for the session to the application server AS using a message in compliance with the SIP protocol, and containing the identity of the terminal EU_{A}. The application server AS executes a program which decides whether or not that terminal can speak at the instant under consideration, in particular as a function of whether or not the (sole) token is presently allocated; and also as a function of filter rules specific to the service (user rights).

During a step 2, if it is possible to give the right to speak to the requesting terminal EU_{A}, the application server AS responds to the terminal EU_{A} by sending a message thereto allocating the token to it, i.e. giving it the exclusive right to speak. The access control server GGSN is ordered by the application server AS to put the connection between the terminal EU_{A} and the network into send mode. The user of that terminal can then speak.

During a step 3, the terminal EU_{A} sends speech signals to the media server MS which broadcasts them to the other terminals EU_{B}, EU_{C}, and EU_{D}. The RTP/RTCP transport protocols (real-time transport protocol/real-time transport control protocol) insert information into the speech packets informing the terminals EU_{B}, EU_{C}, and EU_{D} that the token has been allocated.

During a step 4, the user gives back the right to speak. The terminal EU_{A} sends a token-release message to the application server AS in compliance with the SIP protocol and containing the identity of the terminal EU_{A}.

During a step 5, the application server AS broadcasts an indication that the token has been released to the user terminals EU_{B}, EU_{C}, and EU_{D}, and also to the media server MS; the access control server GGSN is ordered by the application server AS to put the connection between the terminal EU_{A} and the network back into receive mode.

1. A method of managing a token in a telecommunications network to allocate an exclusive right to one user out of a group of users who can request simultaneously to benefit from the same service; the method being characterized in that it consists in:
a requesting user (EU_{A}) sending (1) a token request to an application server (AS);
the application server (AS) then allocating (2) a single token to a requesting user;
the requesting user who has received the token then sending (3) data to a media server (MS) suitable for transporting the data;
said user (EU_{A}) sending (4) a token-release request to the application server (AS); and
finally said application server (AS) broadcasting (5) a message to all of the users (EU_{A}, . . . , EU_{D}) indicating that the token is available.

2. An application server for implementing the method of claim 1, characterized in that it comprises means:
for receiving (1) a token request as sent by a requesting user terminal (EU_{A});
then for enabling said application server (AS) to allocate (2) a single token to said requesting user terminal;
for receiving (4) a token-release request from a user terminal (EU_{A}); and
finally for broadcasting (5) a message indicating that the token is available to all of the user terminals (EU_{A}, . . . , EU_{D}).

3. A telecommunications terminal for implementing the method of claim 1, characterized in that it comprises means:
for sending (1) a token request to an application server (AS);
for receiving (2) a token allocated thereto by the application server (AS);
for sending (3) data to a media server (MS) suitable for transporting the data;
for subsequently sending (4) a token-release request to said application server (AS); and
for receiving (5) a message broadcast by the application server (AS) indicating that the token is available.
